(19) United States
(12) Patent Application Publication
(10) Pub. No.: US 2013/0106900 A1
(43) Pub. Date: May 2, 2013

(54) METHOD AND APPARATUS FOR GENERATING AVATAR

(71) Applicants: Sang hyun Joo, Daejeon (KR); Il kwon Jeong, Daejeon (KR); Byoung tae Choi, Daejeon (KR)

(72) Inventors: Sang hyun Joo, Daejeon (KR); Il kwon Jeong, Daejeon (KR); Byoung tae Choi, Daejeon (KR)

(21) Appl. No.: 13/808,846

(22) PCT Filed: Jul. 5, 2011
(86) PCT No.: PCT/KR11/04918

§ 371 Date: Jan. 7, 2013

Related U.S. Application Data
(60) Provisional application No. 61/361,861, filed on Jul. 6, 2010.

(30) Foreign Application Priority Data
Nov. 2, 2010 (KR) 10-2010-0108416

(51) Int. Cl. G06T 11/00

(52) U.S. Cl. CPC G06T 11/001
USPC 345/593; 345/619

(57) ABSTRACT

Disclosed herein are a method and an apparatus for creating an avatar. A method for creating an avatar in accordance with an exemplary embodiment of the present invention includes: recognizing an object to be created as the avatar; generating distinguishing feature information by recognizing distinguishing features of the object; generating distinguishing feature metadata including the distinguishing feature information; and creating the avatar using the distinguishing feature metadata. Exemplary embodiments of the present invention can impart a difference to the same avatar by creating the avatar using inherent features, that is, distinguishing features included in each object when the avatar for the same object like a twin is created.

### BACKGROUND

1. Field

Exemplary embodiments of the present invention relate to a method and an apparatus for creating an avatar, and more particularly, to a method and an apparatus for creating an avatar using distinguishing features.

2. Description of Related Art

With the development of computer operation function and graphic processing capability and popularization of high-speed Internet line, various three-dimensional online games have been generalized. Further, unlike games achieving specific purposes, a ‘life-type virtual reality’ service that can three-dimensionally implement a real living space and thus, experience virtual reality has also been commercialized.

In particular, the life-type virtual reality service provide environment similar to real environment so as to implement real life in a virtual space. In this case, the life-type virtual reality service needs to provide a three-dimensional stereoscopic space that is similar to reality or is difficult to be searched in real environment and set various correlations between users and implement a natural user avatar.

One of factors that dominate initial impression or use satisfaction of the life-type virtual real service may include user immersion into an avatar. Generally, as a user feels that he/she is united with an avatar, the immersion and satisfaction of the corresponding service are increased. In particular, when an avatar is a center of a service, a shape of an avatar, diversity of composition, and natural action are main factors determining the user immersion into the avatar.

The avatar is created according to an appearance of an object that is a target of the avatars, such as a person, an animal, an object, or the like. That is, the avatar is created based on data regarding the appearance.

The appearance type of the general avatar includes data extracted from a portion representing the appearance of the object. For example, the appearance type of the avatar may include a plurality of children elements such as face, forehead, eyebrows, eyes, nose, cheeks, lips, teeth, chin, makeup, headtype, ears, hair, neck, body, arms, legs, skin, clothes, accessory, or the like. The avatar approximating a human is created using the data.

However, in creating the avatar, when an object that is the original of the avatar is very similar like a twin, there is a problem in that it is very difficult to distinguish the created avatar. In addition, in order to widely create the avatar more approximating the real object, a need exists for additional information in addition to information describing the existing avatar.

### SUMMARY OF THE INVENTION

An embodiment of the present invention is directed to provide a method and an apparatus for creating an avatar capable of imparting a difference to the same avatar by creating the avatar using inherent features, that is, distinguishing features included in each object when the avatar for the same object like a twin is created.

Further, another embodiment of the present invention is directed to provide a method and an apparatus for creating an avatar capable of widely creating an avatar more approximating a real object by describing the avatar using additional information in addition to information describing the existing avatar.

In addition, another embodiment of the present invention is directed to provide a method and an apparatus for creating an avatar capable of rapidly recognizing an object through an avatar even though an appearance of the object is not accurately known.

In accordance with an embodiment of the present invention, a method for creating an avatar includes: recognizing an object to be created as the avatar; generating distinguishing feature information by recognizing distinguishing features of the object; generating distinguishing feature metadata including the distinguishing feature information; and creating the avatar using the distinguishing feature metadata.

In accordance with another embodiment of the present invention, an apparatus for creating an avatar includes: an object recognition unit configured to recognize an object to be created as the avatar; a distinguishing feature recognition unit configured to generate distinguishing feature information by recognizing distinguishing features of the object; a metadata generation unit configured to generate distinguishing feature metadata including the distinguishing feature information; and an avatar creation unit configured to create the avatar using the distinguishing feature metadata.

### BRIEF DESCRIPTION OF THE DRAWINGS

FIG. 1 is a diagram illustrating a configuration of an apparatus for creating an avatar in accordance with an exemplary embodiment of the present invention.

FIG. 2 is a flow chart of a method for creating an avatar in accordance with an exemplary embodiment of the present invention.

FIG. 3 is a diagram illustrating a relationship between distinguishing feature metadata and scar information, tattoo information, and birthmark information.

### DESCRIPTION OF SPECIFIC EMBODIMENTS

Exemplary embodiments of the present invention will be described below in more detail with reference to the accompanying drawings. Only portions needed to understand an operation in accordance with exemplary embodiments of the present invention will be described in the following description. It is to be noted that descriptions of other portions will be omitted so as not to make the subject matters of the present invention obscure.

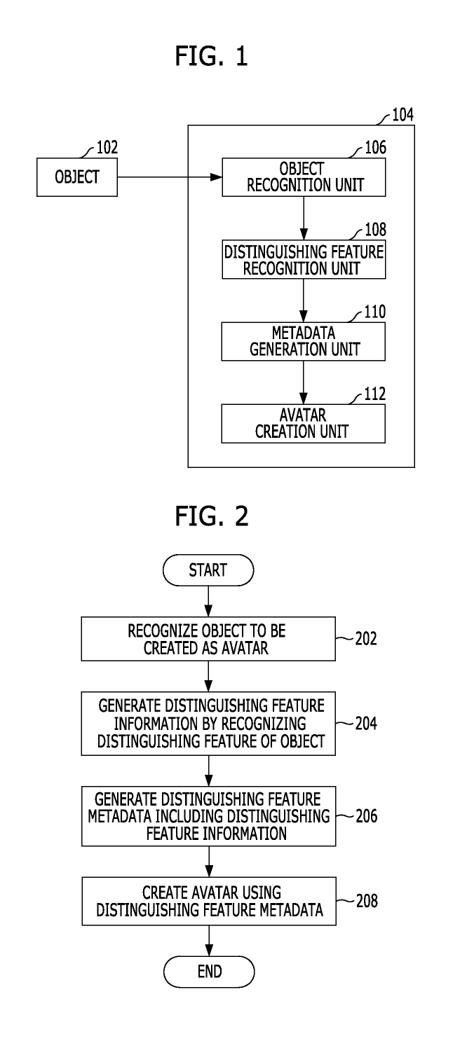

FIG. 1 is a diagram illustrating a configuration of an apparatus for creating an avatar in accordance with an exemplary embodiment of the present invention.

Referring to FIG. 1, an apparatus 104 for creating avatar is configured to include an object recognition unit 106, a distinguishing feature recognition unit 108, a metadata generation unit 110, and an avatar creation unit 112. The object recognition unit 106 recognizes an object 102 to be created as an avatar. In this case, the object 102 includes all objects that may be represented by an avatar such as a human, an animal, an object, or the like.

The distinguishing feature recognition unit 108 recognizes a distinguishing feature of the object 102 and creates distinguishing feature information using the recognized distinguishing features. In this case, the distinguishing features mean additional features capable of distinguishing the object 102 in addition to general features (for example, eyes, ears, nose, mouth) of the object 102. In the exemplary embodiment of the present invention, the distinguishing features include scars, tattoos, birthmarks, or the like.

The metadata generation unit 110 generates distinguishing feature metadata including distinguishing feature information generated by the distinguishing feature recognition unit 108. In the exemplary embodiment of the present invention, the distinguishing feature metadata include scar information, tattoo information, and birthmark information. In addition, the scar information includes shape information, location information, color information, length information, and width information, the tattoo information includes picture information, location information, color information, length information, and width information, and the birthmark information includes shape information, location information, color information, length information, and width information.

Meanwhile, in another exemplary embodiment of the present invention, the scar information includes shape information, location information, and type information, the tattoo information includes location information, scaling information, and picture information, and the birthmark information includes shape information, location information, and color information.

The avatar creation unit 112 creates an avatar using the distinguishing feature metadata generated by the metadata generation unit 110. The avatar creation unit 112 may create an avatar using the metadata including information on general features of the object 102, together with the distinguishing feature metadata.

FIG. 2 is a flow chart of a method for creating an avatar in accordance with an exemplary embodiment of the present invention.

First, an object to be created as an avatar is recognized (202). In this case, the object includes all objects that may be represented by an avatar such as a human, an animal, an object, or the like. Next, the distinguishing feature information is generated by recognizing the distinguishing features of the object (204). In this case, the distinguishing features mean additional features capable of distinguishing the object in addition to the general features (for example, eyes, ears, nose, mouth) of the object. In the exemplary embodiment of the present invention, the distinguishing features include the scars, the tattoos, the birthmarks, or the like.

Then, the distinguishing feature metadata including the distinguishing feature information are generated (206). In the exemplary embodiment of the present invention, the distinguishing feature metadata include the scar information, the tattoo information, and the birthmark information. In addition, the scar information includes shape information, location information, color information, length information, and width information, the tattoo information includes picture information, location information, color information, length information, and width information, and the birthmark information includes shape information, location information, color information, length information, and width information.

Meanwhile, in another exemplary embodiment of the present invention, the scar information includes shape information, location information, and type information, the tattoo information includes location information, scaling information, and picture information, and the birthmark information includes shape information, location information, and color information.

Finally, the avatar is created using the generated distinguishing feature metadata (208). In this case, the avatar may be created using the metadata including the information regarding the general features of the object, together with the distinguishing feature metadata.

Hereinafter, additional feature descriptions for an avatar in accordance with the exemplary embodiment of the present invention, that is, the distinguishing feature metadata will be described.

### <Additional Feature Descriptions for Avatar>

Almost all the persons have at least one distinguishing feature such as scars, birthmarks, tattoos, or the like. A portion of the distinguishing features may not be seen at first sight, but the ‘marks’ are very likely to exist in a body. The distinguishing features are not almost changed and therefore, more stable than other features. The distinguishing features may be used to distinguish persons even in the state in which an appearance of a person is not recognized. Therefore, the distinguishing feature is very important attribute.

The exemplary embodiment of the present invention may represent the distinguishing features having any size and location on a body using distinguishing feature items.

Since a current version of the avatar appearance type structure does not have information representing the distinguishing features as described above, the exemplary embodiment of the present invention adds distinguishing feature parts to the existing avatar appearance type. This makes the avatar type more complete and wide and covers all the details associated with body characteristic attribute.

The distinguishing features may also help searching the person through the avatar when an appearance of a specific person is not completely known.

In creating the avatar representation, a main purpose is to achieve better quality like a real human. For this reason, a description part is configured to include a lot of features that need to be reflected to the avatar.

However, almost the same persons, that is, twins are present in the real world and therefore, when there are no distinguishing features, the avatars thereof may be seen identically. When at least two same avatar types are present, it is possible to include the difference between the avatars using these features. Even non-twin people have specific ‘characters’, that is, scars, tattoos, birthmarks that are found in the body.

According to the existing avatar appearance structure, a distinguishing feature tag is inserted after an ‘avatar appearance type’ tag and is listed with ‘body’, ‘head’, ‘eyes’, ‘ears’, and tags of another same layer, such that the distinguishing feature tag becomes on of children tags. The distinguishing feature tags have three children tags such as scars, tattoos, birthmarks, or the like.

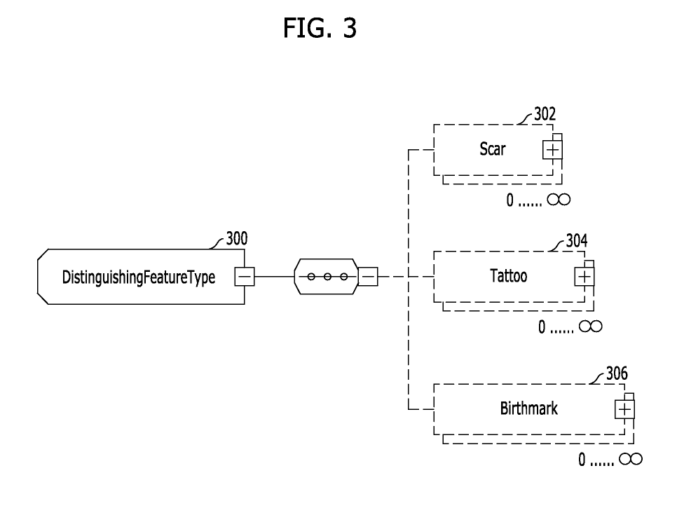

FIG. 3 is a diagram illustrating a relationship between the distinguishing feature metadata and scar information, tattoo information, and birthmark information. As shown in FIG. 3, the distinguishing feature metadata include the scar information, the tattoo information, and the birthmark information.

### First Exemplary Embodiment

In the first exemplary embodiment, the scar tag has three attributes such as a shape, a location, solidification, or the like. The ‘type’ attribute represents a sort of scars. The type attribute includes hypertrophic scars that is subjected to excessive growth (keloid scars become a subset), recessed scars, and stretch marks.

Since the tattoos are a kind of a work of art, anyone may design the tattoos. As a result, all the tattoos are different. For this reason, the exemplary embodiment of the present invention uses a picture representing the appearance of the tattoos. The child attributes of the tattoos have three attributes, such as location, scaling (scaling for an original picture) in addition to a picture.

The birthmark tag has three attributes, such as a location, a shape, a color (RGB value), or the like.

A schema of the distinguishing feature metadata in accordance with the first exemplary embodiment of the present invention is as follows.

```
<!-- ################################################ -->
<!-- Distingusihable Feature Type -->
<!-- ################################################ -->
<complexType name=“DistinguishableFeatureType”>
  <sequence>
    <element name=“Scar” minOccurs=“0”
maxOccurs=“unbounded”>
      <complexType>
        <sequence>
          <element name=“Shape” type=“vwoc:ShapeType”/>
          <element name=“Location”
type=“vwoc:LocationType”/>
          <element name=“Type”>
            <simpleType>
              <restriction base=“string”>
                <enumeration value=“Hypertrophic”/>
                <enumeration value=“Recessed ”/>
                <enumeration value=“Stretch”/>
              </restriction>
            </simpleType>
          </element>
        </sequence>
      </complexType>
    </element>
    <element name=“Tatoo” minOccurs=“0”>
      <complexType>
        <sequence>
          <element name=“Location”
type=“vwoc:LocationType”/>
          <element name=“Scaling” type=“integer”/>
          <element name=“Address” type=“anyURI”/>
        </sequence>
      </complexType>
    </element>
    <element name=“Birthmark” minOccurs=“0”>
      <complexType>
        <sequence>
          <element name=“Shape” type=“vwoc:ShapeType”/>
          <element name=“Location”
type=“vwoc:LocationType”/>
          <element name=“Colour” type=“integer”/>
        </sequence>
      </complexType>
    </element>
  </sequence>
</complexType>
```

[Table 1] represents semantics of the attributes of the scar information included in the distinguishing feature metadata in accordance with the first exemplary embodiment of the present invention.

TABLE 1

| Name | Definition |
|---|---|
| Scar | Describes a group of attributes for the |
| | commands. |
| Shape | The shape of the scar: The shape can only |
| | be elipses and circles. |
| Location | Describe the location of the scar. We use |
| | coordinate or region with |
| | up/down/left/right/center to indicate the |
| | location. For example, left of the face. |
| Type | Scar types include hypertrophic scars (of |
| | which keloid scars be considered a |
| | subset) which experience excessive |
| | growth, recessed scars, and stretch marks |
| | (striae). |

[Table 2] represents semantics of the attributes of the tattoo information included in the distinguishing feature metadata in accordance with the first exemplary embodiment of the present invention.

TABLE 2

| Name | Definition |
|---|---|
| Tattoo | Describes a group of attributes for the |
| | commands. |
| location | Describe the location of the tattoo. We |
| | can use coordinate or region with |
| | up/down/right/write/canter to achieve |
| | this. |
| Scaling | Describe the size of the tattoo using the |
| | scaling to the original picture file. |
| picture | It is the address of the picture of the |
| | tattoo, we use URL. |

[Table 3] represents semantics of the attributes of the birthmark information included in the distinguishing feature metadata in accordance with the first exemplary embodiment of the present invention.

TABLE 3

| Name | Definition |
|---|---|
| BirthMark | Describes a group of attributes for the |
| | commands. |
| Shape | The shape of the birthmark, it contains |
| | several basic shapes. Such as circle, |
| | elipse and polygon. |
| Location | Describe the location of the birthmark. We |
| | use coordinate or region with |
| | up/down/left/right/center to indicate the |
| | location. For example, left of the face. |
| Color | It is the colour of the birthmark. We use |
| | RGB to describe the colour. |

### Second Exemplary Embodiment

In the second exemplary embodiment, the scar tag has five attributes. First is a shape of scars and second is a location. The remaining attributes are a color, a length, and a width and theses attributes is to detect a size of scars.

The tattoo tag has five attributes such as a picture, a location, a length, a width, and a color. The location, length, and width are to represent the size of scars.

The birthmark tag has five attributes, such as a location, a shape, a color (RGB value), a length, a width, or the like.

A schema of the distinguishing feature metadata in accordance with the second exemplary embodiment of the present invention is as follows.

```
<xs:complexType name=“DistinguishingFeatureType”>
  <xs:sequence>
    <xs:element name=“Scar” minOccurs=“0”
maxOccurs=“unbounded”>
      <xs:complexType>
        <xs:sequence>
          <xs:element name=“Shape” type=“xs:anyURI”
minOccurs=“0”/>
          <xs:element name=“Location”
type=“vwoc:LocationType” minOccurs=“0”/>
          <xs:element name=“Color” type=“mpegvct:colorType”
minOccurs=“0”/>
          <xs:element name=“Length” minOccurs=“0”/>
          <xs:element name=“Width” minOccurs=“0”/>
        </xs:sequence>
      </xs:complexType>
    </xs:element>
    <xs:element name=“Tattoo” minOccurs=“0”
maxOccurs=“unbounded”>
      <xs:complexType>
        <xs:sequence>
          <xs:element name=“Picture” type=“xs:anyURI”
minOccurs=“0”/>
          <xs:element name=“Location”
type=“vwoc:LocationType” minOccurs=“0”/>
          <xs:element name=“Color” type=“mpegvct:colorType”
minOccurs=“0”/>
          <xs:element name=“Length” minOccurs=“0”/>
          <xs:element name=“Width” minOccurs=“0”/>
        </xs:sequence>
      </xs:complexType>
    </xs:element>
    <xs:element name=“Birthmark” minOccurs=“0”
maxOccurs=“unbounded”>
      <xs:complexType>
        <xs:sequence>
        <xs:element name=“Shape” type=“xs:anyURI”
minOccurs=“0”/>
          <xs:element name=“Location”
type=“vwoc:LocationType” minOccurs=“0”/>
          <xs:element name=“Color” type=“mpegvct:colorType”
minOccurs=“0”/>
          <xs:element name=“Length” minOccurs=“0”/>
          <xs:element name=“Width” minOccurs=“0”/>
        </xs:sequence>
      </xs:complexType>
    </xs:element>
  </xs:sequence>
</xs:complexType>
```

[Table 4] represents semantics of the attributes of the scar information included in the distinguishing feature metadata in accordance with the second exemplary embodiment of the present invention.

TABLE 4

| Name | Definition |
|---|---|
| Scar | Describes a group of attributes for the commands. |
| Shape | The shape of the scar |
| Location | Describe the location of the scar. We use coordinate |
| | or region with up/down/left/right/center to indicate |
| | the location. For example, left of the face. |
| Length | The length of the scar (in m) |
| Width | The width of the scar (in m) |
| Color | The scar's colour (RGB) |

[Table 5] represents semantics of the attributes of the tattoo information included in the distinguishing feature metadata in accordance with the second exemplary embodiment of the present invention.

TABLE 5

| Name | Definition |
|---|---|
| Tattoo | Describes a group of attributes for the commands. |
| Location | Describe the location of the tattoo. We can use |
| | coordinate or region with up/down/right/write/canter |
| | to achieve this. |
| Picture | It is the address of the picture of the tattoo, we |
| | use URL. |
| Length | The length of the tattoo (in m) |
| Width | The width of the tattoo (in m) |
| Color | The tattoo color (RGB) |

[Table 6] represents semantics of the attributes of the birthmark information included in the distinguishing feature metadata in accordance with the second exemplary embodiment of the present invention.

TABLE 6

| Name | Definition |
|---|---|
| BirthMark | Describes a group of attributes for the commands. |
| Shape | The shape of the birthmark. |
| Length | The length of the birthmark (in m) |
| Width | The width of the birthmark (in m) |
| Color | It is the colour of the birthmark. We use RGB to |
| | describe the colour. |
| Location | Describe the location of the tattoo. We can use |
| | coordinate or region with up/down/right/write/canter |
| | to achieve this. |

Even though the appearance of a human is not accurately known, the distinguishing features may help rapidly recognizing the appearance of a human. In addition, when the two same avatars are created, the difference therebetween may be added. The exemplary embodiments of the present invention can widely create the avatars more approaching the real body type of a human.

As set forth above, the exemplary embodiments of the present invention can impart the difference to the same avatar by creating the avatar using the inherent features, that is, the distinguishing features included in each object when the avatar for the same object like a twin is created.

In addition, the exemplary embodiments of the present invention can widely create the avatar more approximating the real object by describing the avatar using the additional information in addition to the information describing the existing avatar.

In addition, the exemplary embodiments of the present invention can rapidly recognize the object through the avatar even though the appearance of the object is not accurately known.

While the present invention has been described with respect to the specific embodiments, it will be apparent to those skilled in the art that various changes and modifications may be made without departing from the spirit and scope of the invention. Accordingly, the scope of the invention is not limited to exemplary embodiments as described above and is defined by the following claims and equivalents to the scope the claims.

What is claimed is:

1. A method for creating an avatar, comprising:
recognizing an object to be created as the avatar;
generating distinguishing feature information by recognizing distinguishing features of the object;
generating distinguishing feature metadata including the distinguishing feature information; and
creating the avatar using the distinguishing feature metadata.

2. The method of claim 1, wherein the distinguishing feature metadata includes scar information, tattoo information, and birthmark information.

3. The method of claim 2, wherein the scar information includes shape information, location information, color information, length information, and width information.

4. The method of claim 2, wherein the tattoo information includes picture information, location information, color information, length information, and width information.

5. The method of claim 2, wherein the birthmark information includes shape information, location information, color information, length information, and width information.

6. An apparatus for creating an avatar, comprising:
an object recognition unit configured to recognize an object to be created as the avatar;
a distinguishing feature recognition unit configured to generate distinguishing feature information by recognizing distinguishing features of the object;
a metadata generation unit configured to generate distinguishing feature metadata including the distinguishing feature information; and
an avatar creation unit configured to create the avatar using the distinguishing feature metadata.

7. The apparatus of claim 6, wherein the distinguishing feature metadata includes scar information, tattoo information, and birthmark information.

8. The apparatus of claim 7, wherein the scar information includes shape information, location information, color information, length information, and width information.

9. The apparatus of claim 7, wherein the tattoo information includes picture information, location information, color information, length information, and width information.

10. The apparatus of claim 7, wherein the birthmark information includes shape information, location information, color information, length information, and width information.
